(19) United States
(12) Patent Application Publication
(10) Pub. No.: US 2013/0288209 A1
(43) Pub. Date: Oct. 31, 2013

(54) BOOKLET ASSEMBLY WITH GRID BOX AND METHOD TO HELP CHILDREN TO WRITE AND CREATE

(71) Applicant: Alexis Galindo, East Rutherford, NJ (US)

(72) Inventor: Alexis Galindo, East Rutherford, NJ (US)

(21) Appl. No.: 13/873,772

(22) Filed: Apr. 30, 2013

Related U.S. Application Data
(60) Provisional application No. 61/640,179, filed on Apr. 30, 2012.

(51) Int. Cl. G09B 11/00

(52) U.S. Cl. CPC G09B 11/00
USPC 434/162

(57) ABSTRACT

The current invention discloses a grid box that may be printed in a booklet to help children to learn writing, improve handwriting, and create their own content. The grid box has four parallel lines defining three spaces that may be used for standardized handwriting of English and Spanish words and letters. The middle space of the grid box is shaded to facilitate the process to standardize handwriting. The grid boxes are preferably printed in a booklet assembly having two or more booklets stacked together. These booklets have different lengths and widths, while the bigger booklets are positioned beneath the smaller booklets, making a stepped arrangement. With picturing pasting sections and leading texts, the children learning to write may be prompted to handwrite letters and words in the grid boxes while completing a story.

### CLAIM OF PRIORITY

This application is a U.S. utility patent application claiming priority from U.S. provisional application 61/640,179 filed on Apr. 30, 2012, the contents of which are fully incorporated by reference.

### FIELD OF THE INVENTION

The invention relates to a booklet having specially designed grid boxes and related methods to help children to learn writing and create their own content. More particularly, the current invention relates to using a booklet assembly having specially designed pre-printed grid boxes to help children to develop improved handwriting and writing skills.

### BACKGROUND OF THE INVENTION

It is imperative for a person to learn to write. It is also beneficial for a person to develop legible and clear handwriting. Moreover, it is desirable to begin the development of such abilities at a young age. Schools and parents have spent enormous time and resources on instructing children to write and providing templates to standardize their handwritings. The current invention aims at providing help to children in such efforts.

Handwriting sheets have been available for some time. These sheets usually use pre-printed grids to help children to align handwritten letters and words. Most of these grids, however, consist of three parallel lines defining two separate spaces. With these kinds of grids, some of the English or Spanish letters will extend out of the frame of the grids, making it more difficult to standardize the handwriting.

Another tool used in the effort to help children to write is the practice booklets children use. The current invention directs to a stepped edge booklet assembly. Pads or booklets having stepped pages—pages that have different widths—have been developed for the purpose of easy access. For example, Canadian patent CA1091714 discloses a notebook for addresses comprising a base plate folded in two, a plurality of paper slips for records, each paper slip being folded in two at a substantially central transverse line so as to form front and rear flaps. The paper slips are steppedly arranged and attached to the base plate. There is a cover having two pockets into which both end portions of the base plate are inserted. Preferably the cover has a transparent flap portion for showing indices printed to the end of the paper slip. The Canadian patent identified here, however, is not directed to children's writing booklets. Moreover, the stepped-page notebook in the Canadian patent only has the stepped arrangement in one dimension.

The current invention teaches a specially designed stepped edge booklet assembly distinct from the currently available booklets. Employing the novel grid box that is also disclosed here, the current invention promotes a method to help children to learn writing and improve their handwriting at the same time.

Therefore, various implements are known in the art, but fail to address all of the problems solved by the invention described herein. A preferred embodiment of this invention is illustrated in the accompanying drawings and will be described in more detail herein below.

### SUMMARY OF THE INVENTION

The present invention discloses a grid box, a booklet assembly with preprinted such grid boxes and the corresponding methods to help children to learn writing and improve handwriting. The grid box may comprise a first line, a second line, a third line, and a fourth line wherein the four lines are parallel to one another in such order, each two adjacent lines being separated by a first space, a second space, and a third space respectively, the first space, the second space, and the third space having a substantially equal width, wherein the second space is shaded, and the grid box is used to standardize handwriting of English letters and words.

The grid box disclosed here has three spaces, instead of two, which is the common form used in handwriting practice sheets. As indicated above, the two-space grid box has very significant shortcomings because letters such as “j” and “p” would not fit entirely within the grid boxes, slowing the process of learning proper handwriting by children. On the other hand, the three-space grid boxes disclosed by the current invention may accommodate all the English and Spanish letters in their entirety. Moreover, the grid boxes disclosed here have a highlighted middle space that facilitates a child to correctly locate and position the letters because it is easier to recognize. The second line may also be bold, if needed, further facilitating locating the middle space and the improvement of handwriting.

On a page, a plurality of such three-space grid boxes may be printed to provide a practice sheet for a child to learn proper handwriting. Moreover, the grid boxes may be combined with others features that help a child to learn not only handwriting, but also writing in general. The form of medium disclosed by the current invention is a booklet assembly having stepped-edge booklets.

The booklet assembly may comprise a first booklet having a first cover page and first booklet inner pages sharing a first lower edge and a first left edge, wherein the first cover page and first booklet inner pages having a similar first length and a similar first width; a second booklet having a second cover page and second booklet inner pages sharing a second lower edge and a second left edge, wherein the second cover page and second booklet inner pages having a similar second length and a similar second width; wherein the first booklet is positioned above the second booklet, the first left edge and the second left edge are overlappingly aligned, the first booklet and the second booklet are bound together on the first left edge and the second left edge using a binding assembly, the first length is shorter than the second length, and the first width is shorter than the second width.

Although the booklet assembly disclosed above has two booklets having different widths and lengths, it is quite possible that there are more booklets combined together. The key feature is that the booklets have different widths and lengths. Moreover, the only requirement for binding is the left edges of the booklets are bound together. Though it is preferred that the lower edges are aligned, that is not a firm requirement.

The booklets may be bound together with any method that is proper. Examples of binding options include but are not limited to: coil binding, comb binding, hard cover binding, saddle stitching, velo binding, wire binding, spiral binding, tape binding, casewrap binding, dust jacket binding, Perfect binding, three-ring binding. As long as the left edges of the booklets are bound while the left edges are properly aligned and easy access to each booklet is assured, the binding method is acceptable.

The benefit of using a step-edged booklet assembly is multi-fold. One apparent advantage is that the individual booklets may be used for specific purposes. For example, one booklet may be used as a diary and another as a practice book for remembering new words. With the step-edged arrangement, the child using the booklet assembly may have easier access to each booklet. While these booklets are bound together, the chance of losing or forgetting one booklet is reduced.

The booklets may have a plurality of the three-space grid boxes printed in the inner pages of the booklets. Some additional features may be included to enhance the effectiveness of the process to help children to write. For example, the child using the booklet may be prompted to write a story. Title grid boxes may be left blank so that the child may give a title to the story. Picture pasting sections may be used to paste a picture related to the story. In addition, leading texts in or outside the grid boxes may be used to urge the child to write. With the pre-printed grid boxes on a story leading page, one or more story proceeding pages, and a story ending page, the child may learn to write a story and improve his/her handwriting at the same time.

In general, the present invention succeeds in conferring the following, and others not mentioned, desirable and useful benefits and objectives.

It is an object of the present invention to provide a booklet assembly that is easy to use.

It is another object of the present invention to provide a three-space grid box that may be pre-printed on a medium to help children to improve their handwriting.

It is another object of the present invention to provide a booklet assembly that may facilitate the access to the individual booklets.

Yet another object of the present invention is to provide a booklet assembly that includes multiple booklets having different widths and lengths.

It is another object of the present invention to provide a three-space grid box having the middle space shaded to allow easier identification by the child trying to improve his/her handwriting.

Yet another object of the present invention is to provide a grid box that has a bold line to serve as clear indication of letter placement.

Still another object of the present invention is to provide a method to help children to improve their handwriting using the three-space grid boxes.

It is another object of the present invention to provide a method to help children to write using leading texts and picture-pasting sections.

Still another object of the present invention is to provide a booklet assembly that is inexpensive.

### BRIEF DESCRIPTION OF THE DRAWINGS

FIG. 1A illustrates a story leading page including a number of grid boxes.

FIG. 1B illustrates a story proceeding page including a number of grid boxes.

FIG. 1C illustrates a story ending page including a number of grid boxes.

FIG. 2A shows a top perspective view of a closed stepped booklet assembly.

FIG. 2B shows a top perspective view of an open stepped booklet assembly.

### DESCRIPTION OF THE PREFERRED EMBODIMENTS

The preferred embodiments of the present invention will now be described with reference to the drawings. Identical elements in the various figures are identified, as far as possible, with the same reference numerals. The preferred embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

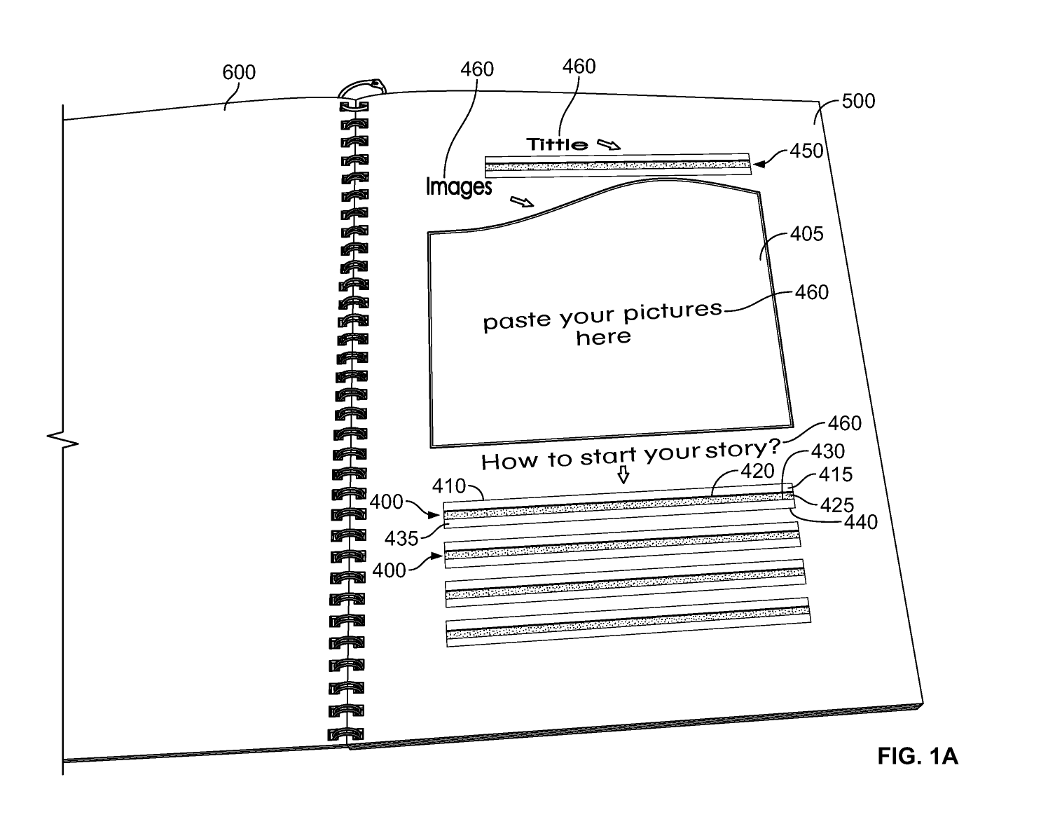

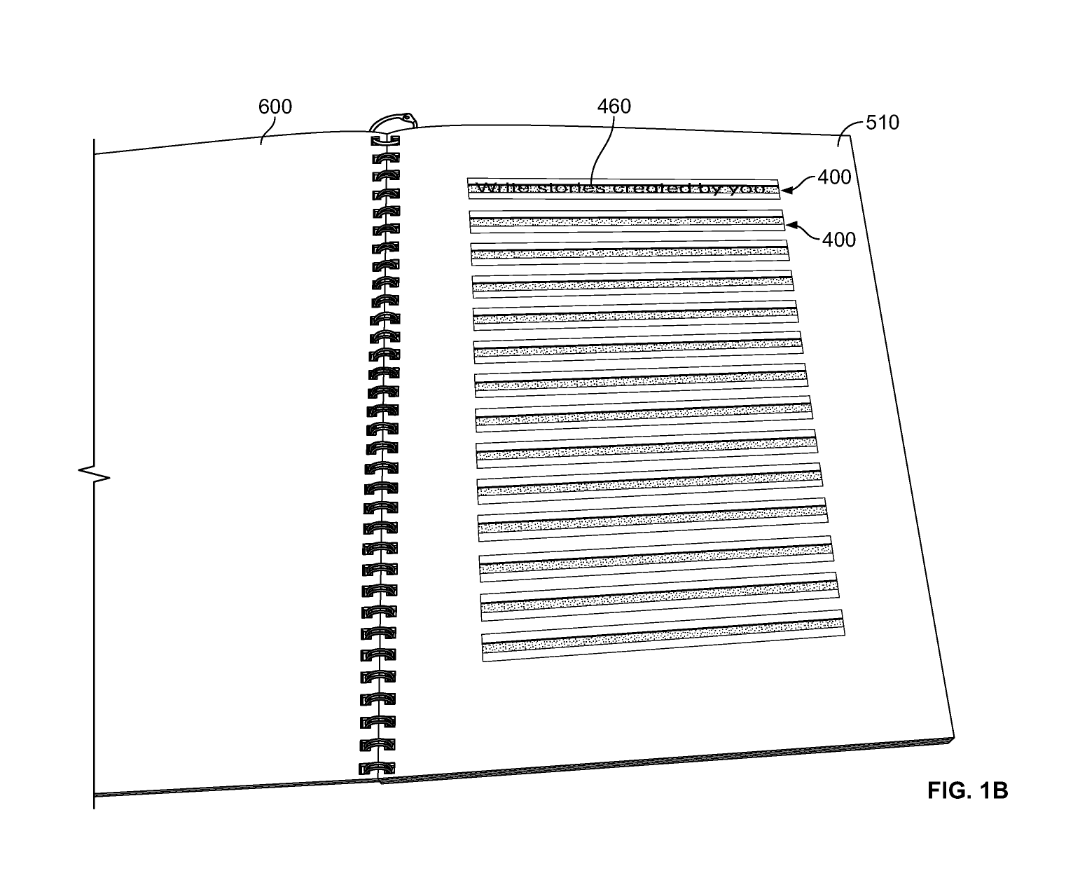

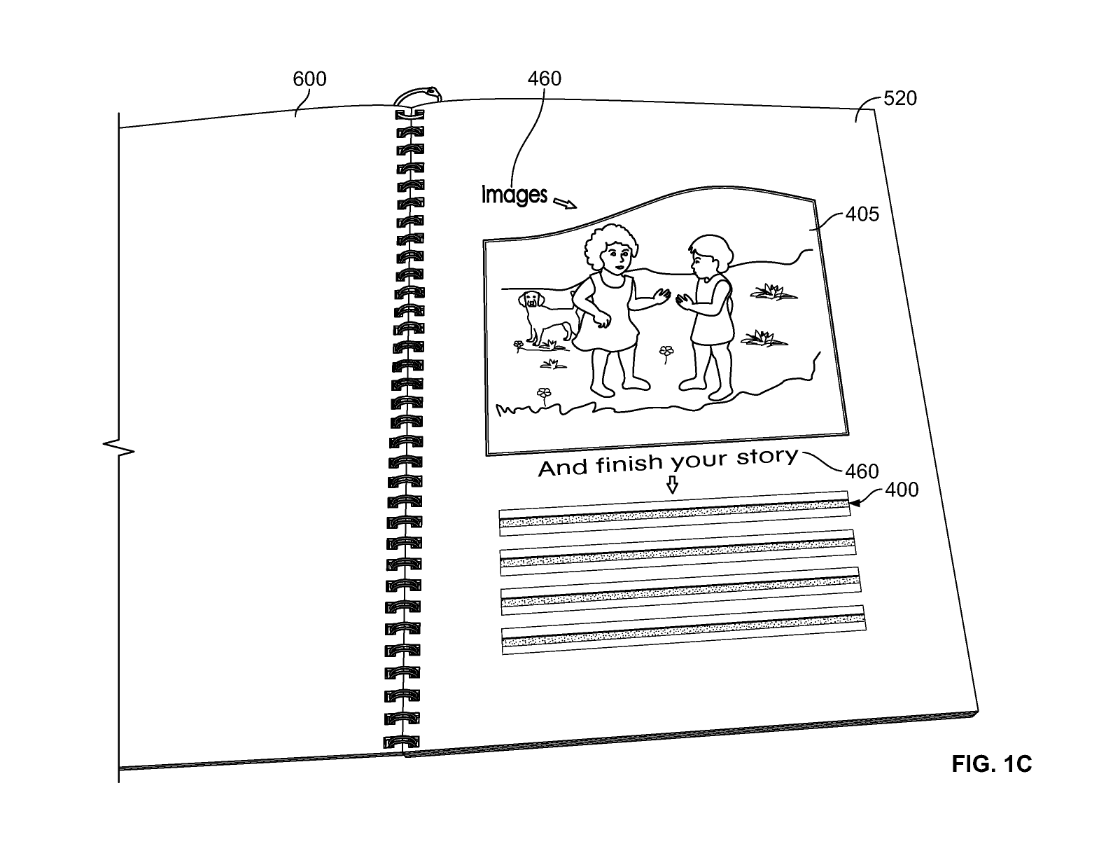

FIGS. 1A, 1B and 1C demonstrate a series of pages that have a plurality of grid boxes pre-printed on them. The pages are designed to prompt a child who is trying to improve his writing and handwriting to write a story and paste corresponding pictures to the pages.

FIG. 1A illustrates a story leading page including a number of grid boxes. Shown in FIG. 1 is a back page 600 and a story leading page 500, and there are grid boxes 400, a picture pasting section 405, and leading texts 460 pre-printed on the story leading page 500. For clarity purposes, not all the grid boxes 400 are marked. In FIG. 1A, the picture pasting section 405 has no picture in it.

The grid box 400 is a central feature of the current invention. The grid box 400 comprises a first line 410, a second line 420, a third line 430, and a fourth line 440. The four lines are parallel to one another in such an order and each two adjacent lines being separated by a first space 415, a second space 425, and a third space 435, wherein the second space is shaded. The grid box may be used for practicing standardized handwriting for letters and words of English, Spanish, and other alphabetic languages.

Taking English as example, all the capital letters may occupy the top two spaces. For the non-capital letters, “a,” “c,” “e,” “m,” “n,” “o,” “r,” “u,” “v,” “w,” “x” and “z” may occupy only the second space; “b,” “d,” “h,” “i,” “k,” “l,” “s,” and “t,” may occupy the first and the second space; “g,” “p,” “q,” and “y” may occupy the second and the third space; and “f,” and “j” may occupy all three spaces.

The shading of the second space 425 is important because unlike other designs for handwriting grid boxes, the current grid box 400 has the advantage of being easy to use and reminds a user where the middle space of the grid box is. As indicated above, for ALL the letters, the second space 425 is occupied. Thus, it is essential for a child that is trying to improve his/her handwriting to locate the second space 425 and use it as the anchoring point for standardized handwriting. The shading of the second space is designed for such a purpose. While the second space 425 is shaded, the first and third spaces may be left unshaded. Alternatively, the first space 415 and the third space 435 may be shaded as well, as long as the shading for the second space 425 is darker than those of the first space 415 and second space 425.

The grid box 400 may be simply black and white with grey shadings for the second space 425. Alternatively, the grid box may be colored. The lines and the spaces may have colors that are distinctive. It is preferred that the second space 425 is colored while the first space 415 and the third space 435 are not, making the second space 425 more distinct and easier to locate.

The story leading page 500 may be used to prompt a child to write a story in the blank spaces that are provided by the grid boxes 400. The story leading page 500 is just one of the possible ways to help a child to improve his/her writing and handwriting. Other options may be acceptable as long as this purpose is served. For example, the story leading page 500 may be changed to a word spelling page that helps a child to learn spelling of words and standardize his/her handwriting in the grid boxes 400. Accordingly, the leading texts 460 may be designed to fit the goal of the page. The leading texts 460 shown in FIG. 1A are designed to ask the children to come up with a title in the title grid box 450, paste a picture in the picture pasting section 405, and start a story in the grid boxes 400 under the picture pasting section 405. The leading texts 460 may be placed in or out of the grid boxes 400.

The back page 600 is left blank in FIG. 1A. However, it should be noted that the back page 600 may be used in many ways. For example, the back page 600 may be pre-printed with grid boxes 400 and serve as a proceeding page of the story leading page 500. Alternatively, the back page 600 may accommodate page designs that are similar or different to what is shown in the story leading page 500, only in an up-side-down manner. With this design, the booklet may be used starting from either the front or the back. For example, the story leading page 500 shown in FIG. 1A may have leading texts 460 in English and the up-side-down page on the back page 600 may have leading texts 460 in Spanish, allowing a child to writing in English starting from the front pages and in Spanish starting from the back pages.

FIG. 1B illustrates a story proceeding page including a number of grid boxes. Shown in FIG. 1B are the back page 600 and a story proceeding page 510. There are grid boxes 400 and leading texts 460 pre-printed in the story proceeding page 510. For clarity purposes, not all the grid boxes 400 are marked. The details of the grid boxes 400 are not marked.

The story proceeding page 510 helps to prompt a child learning to write to continue his/her story started on the story leading page 500. Moreover, unlike FIG. 1A, wherein the leading texts 460 are placed outside the grid boxes 400, in FIG. 1B the leading texts 460 are pre-printed in the grid boxes 400. In such a manner, the leading texts 460 also provide an example for the child as standardized handwriting. As indicated above, the grid box 400 is primarily designed for English and Spanish. However, other alphabetic languages may also be practiced in the grid box 400.

FIG. 1C illustrates a story ending page including a number of grid boxes. Shown in FIG. 1C are the back page 600 and a story ending page 520, and there are grid boxes 400, a picture pasting section 405, and leading texts 460 pre-printed on the story ending page 520. For clarity purposes, not all the grid boxes 400 are marked. The details of the grid boxes 400 are not marked.

In FIG. 1C, a picture is already pasted in the picture pasting section 405. The story ending page 520 is designed to prompt the child to end the story and write in the grid boxes 400 letters and words related to the picture pasted. Together with the story leading page 500 and the story proceeding page 510, the story ending page 520 makes up a complete section of specially designed pages to help a child to learn writing and improve his/her handwriting. Such sections may be adopted in a booklet designed for a child's diary, or it may be used for a homework projects. Using the story leading page 500, story proceeding pages 510, and the story ending page 520, the current invention helps children to improve writing skills and create stories and diaries in the process.

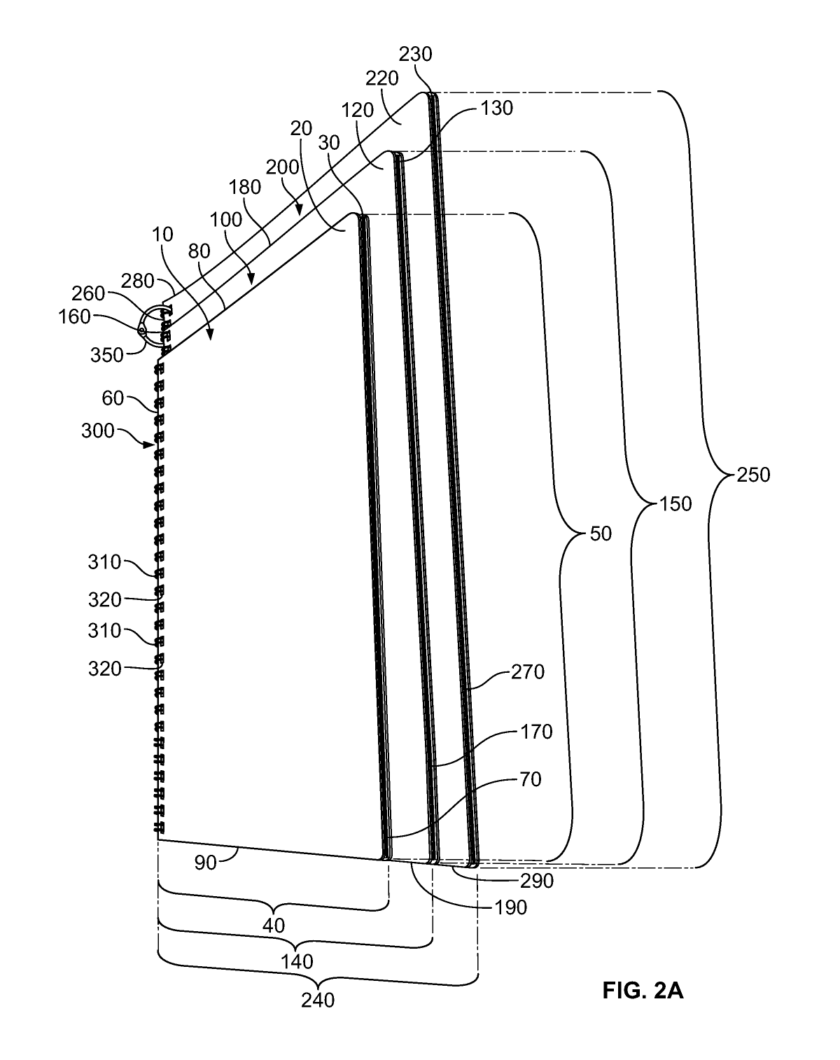

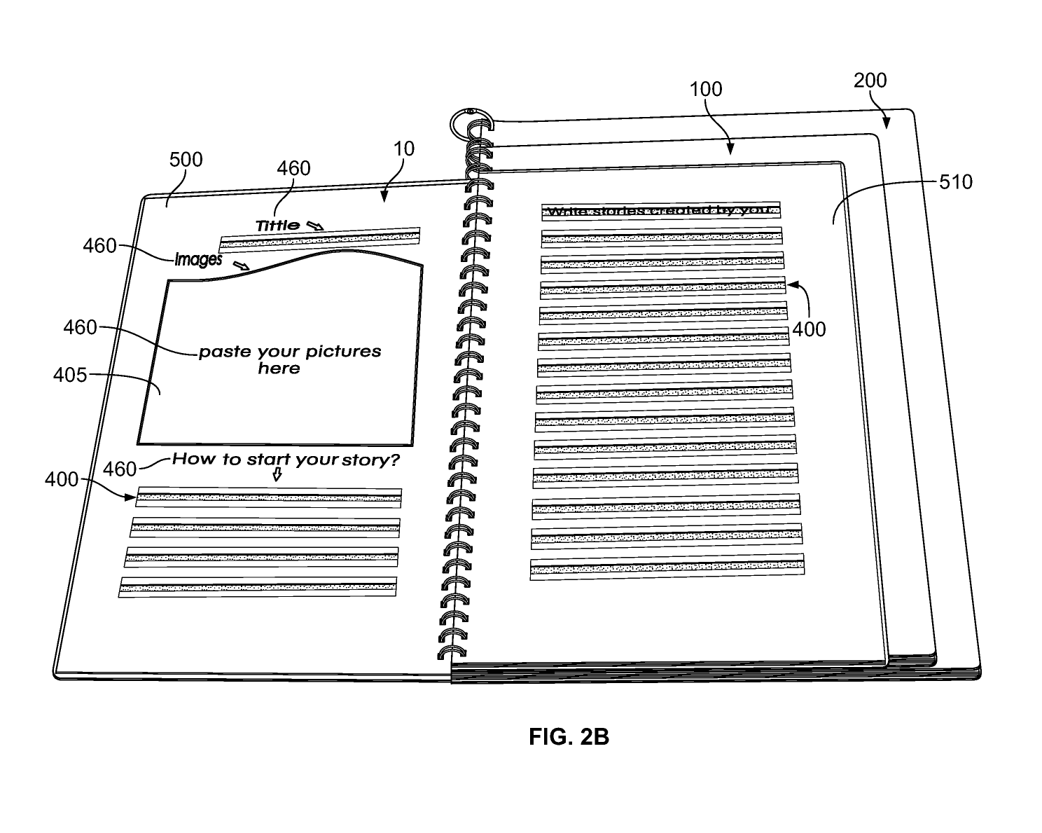

FIG. 2A shows a top perspective view of a closed stepped booklet assembly. Shown in FIG. 2A is the booklet assembly 1 having a first booklet 10, a second booklet 100, and a third booklet 200. The first booklet 10 has a first cover page 20, first booklet inner pages 30, a first width 40, a first length 50, a first left edge 60, a first right edge 70, a first top edge 80, and a first bottom edge 90. In addition, the second booklet 100 has a second cover page 120, second booklet inner pages 130, a second width 140, a second length 150, a second left edge 160, a second right edge 170, a second top edge 180, and a second bottom edge 190. Similarly, the third booklet 200 has a third cover page 220, third booklet inner pages 230, a third width 240, a third length 250, a third left edge 260, a third right edge 270, a third top edge 280, and a third bottom edge 290. As shown in FIG. 2A, the first booklet 10 is dispose on top of the second booklet 100 and the second booklet 100 is disposed on the third booklet 200.

It should be noted that although three booklets are included in the booklet assembly 1 shown in FIG. 2A, there is no limitation as to how many booklets may be included. Preferably, the number of booklets is between 2-10. The key feature for binding the booklets together is that the left edges of the booklets are aligned and bound together, so that turning the pages of each booklet is unhindered. FIG. 2A shows the preferred arrangement that the bottom edges of the booklets are also aligned. However, such a feature is not a firm requirement and the bottom edges of the booklet may also be arranged as stepped, just as the right and top edges.

The first length 50 is shorter than the second length 150 and the second length 150 is shorter than the third length 250. Similar, the first width 40 is shorter than the second width 140 and the second width 140 is shorter than the third width 240. Generally the lengths and the widths of the individual booklets may range from 0.5 to 50 inches (1.27 to 127 cm), with the preferred range to be from 5 to 15 inches (12.7 to 38.1 cm). The length of a particular booklet is preferred to be longer than or equal to the width. It is also preferred that the difference between the first length 50 and second length 150 is similar to the difference between the second length 150 and third length 250. Similarly, it is preferred that the difference between the first width 40 and second width 140 is similar to the difference between the second width 140 and the third width 240. The difference should be between 0.1 to 3 inches (0.25 to 7.6 cm), with the preferred range being 0.3-1.5 inches (0.76 to 12.7 cm).

The booklets are bound on the left edges by a binding assembly 300. In FIG. 2A, the binding assembly 300 comprises a binding coil 310 and a plurality of binding holes 320 on the left edges. The binding assembly 300 may take any form that is proper to bind the booklet together. As indicated above, binding options include but are not limited to: coil binding, comb binding, hard cover binding, saddle stitching, velo binding, wire binding, spiral binding, tape binding, casewrap binding, dust jacket binding, Perfect binding, three-ring binding, with coil binding and three-ring binding as the preferred methods.

The stepped edge design of the booklet assembly 1 significantly helps the child learning to write by combining multiple booklets together and allowing easy access to each booklet. Each booklet may be used for the same or different purposes. For example, the first booklet 10 may be used as a diary book, the second booklet 100 may be used as a word spelling book, and the third booklet 200 may be used as a coloring and writing book. All the features described for FIGS. 1A-1C may be adopted for the booklets. Since the booklets are different in sizes, each booklet may be used for a specific purpose according to its size.

FIG. 2B shows a top perspective view of an open stepped booklet assembly 1. Shown in FIG. 2B are the booklet assembly 1 having a first booklet 10, a second booklet 100, and a third booklet 200, while the first booklet 10 is opened to display a story leading page 500 and a story proceeding page 510, as shown in FIGS. 1A and 1B. Preprinted on the story leading page 500 are the grid boxes 400, the picture pasting section 405, and the leading texts 460. Preprinted on the story proceeding page 510 are the grid boxes 400 and the leading texts 460. For clarity purposes, not all the grid boxes 400 are marked. The details of the grid boxes 400 are not marked.

FIG. 2B demonstrates that the first booklet 10 may be used as a story book with the story leading page 500, story proceeding page 510, and story ending page 520 designs as shown in FIGS. 1A-1C. Here the front page and back page are used in a subsequent manner. Alternatively, as indicated above, the front pages and the back pages may be pre-printed in an up-side-down manner, allowing use of the booklet in two opposite directions.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1: A grid box to be printed or displayed on a medium to help a person to improve handwriting, comprising:
a first line, a second line, a third line, and a fourth line wherein the four lines are parallel to one another in such order,
each two adjacent lines being separated by a first space, a second space, and a third space respectively, the first space, the second space, and the third space having a substantially equal width, wherein
the second space is shaded with a first shading, and
the grid box is used to standardize handwriting of letters and words of English Spanish or.

2: The grid box of claim 1, wherein the first and third spaces are shaded with a second shading, wherein the second shading is lighter than the first shading.

3: The grid box of claim 1, wherein the grid box is printed on a page of a booklet.

4: A booklet comprising a plurality of pages, each page has a plurality of the grid boxes as in claim 1 printed in parallel on the page.

5: The booklet of claim 4, wherein one of the grid boxes has pre-printed words displayed in the grid box.

6: A booklet comprising a plurality of pages, at least one of the pages is a story leading page, the story leading page has a picture pasting section and a plurality of the grid boxes as in claim 1 printed in parallel on the story leading page.

7: The booklet of claim 6, wherein one of the grid boxes has pre-printed words displayed in the grid box.

8: A booklet assembly, comprising:
a first booklet having a first cover page and first booklet inner pages sharing a first lower edge and a first left edge, wherein the first cover page and first booklet inner pages have a similar first length and a similar first width;
a second booklet having a second cover page and second booklet inner pages sharing a second lower edge and a second left edge, wherein the second cover page and second booklet inner pages have a similar second length and a similar second width;
wherein the first booklet is positioned above the second booklet,
the first left edge and the second left edge are overlappingly aligned,
the first booklet and the second booklet are bound together on the first left edge and the second left edge using a binding assembly,
the first length is shorter than the second length, and
the first width is shorter than the second width.

9: The booklet assembly of claim 8, wherein the first lower edge and the second lower edge are overlappingly aligned.

10: The booklet assembly of claim 8, wherein there are through holes adjacent to the first left edge and the second left edge, and the binding assembly comprises coiled wires threading through the through holes.

11: The booklet assembly of claim 8, wherein each first booklet inner page has a plurality of grid boxes printed on the first booklet inner page, each grid box being used to help a person to improve handwriting, the grid box comprising:
a first line, a second line, a third line, and a fourth line wherein the four lines are parallel to one another in such order,
each two adjacent lines being separated by a first space, a second space, and a third space respectively, the first space, the second space, and the third space having a substantially equal width, wherein
the second space is shaded with a first shading,
the grid box is used for standardize handwriting of English letters and words.

12: The booklet assembly of claim 11, wherein the second booklet inner pages have a plurality of grid boxes printed on each second booklet inner page, each grid box having a same format as in claim 11.

13: The booklet assembly of claim 12, wherein each of the first booklet inner pages and second booklet inner pages has a front side and a back side, the grid boxes are printed on both the front side and back side.

14: The booklet assembly of claim 8, further comprising a third booklet having a third cover page and third booklet inner pages sharing a third lower edge and a third left edge, wherein the third cover page and third booklet inner pages having a similar third length and a similar third width;
wherein the second booklet is positioned above the third booklet,
the second left edge and the third ledge edge are overlappingly aligned,
the first booklet, the second booklet and the third booklet are bound together on the first left edge, the second left edge, and the third left edge using a binding assembly,
the second width is shorter than the third length, and
the second width is shorter than the third width.

15: A method to help a person improve handwriting and writing, comprising:
providing a page pre-printed with grid boxes, wherein the grid box has
a first line, a second line, a third line, and a fourth line wherein the four lines are parallel to one another in such order,
each two adjacent lines being separated by a first space, a second space, and a third space respectively, the first space, the second space, and the third space having a substantially equal width, wherein
the second space is shaded with a first shading,
the grid box is used for standardize handwriting of English letters and words, and
letting the person write English or Spanish word or letters in the grid boxes in a standardized format.

16: The method as claim 15, wherein the page includes a picturing pasting section.

17: The method as claim 16, further comprising: directing the person to past a picture related to the letters and words in the picturing pasting section.

18: The method as claim 16, further comprising: using leading texts to prompt the person to paste a picture to the picture pasting section and write letters and words in the grid boxes related to the picture.
